(19) United States
(12) Patent Application Publication
(10) Pub. No.: US 2014/0110496 A1
(43) Pub. Date: Apr. 24, 2014

(54) SCENT DELIVERY DEVICE

(71) Applicants: Odis Sherrill, Clanton, AL (US); Bobby Sherrill, Clanton, AL (US)

(72) Inventors: Odis Sherrill, Clanton, AL (US); Bobby Sherrill, Clanton, AL (US)

(21) Appl. No.: 13/658,574

(22) Filed: Oct. 23, 2012

(51) Int. Cl. A01M 29/12; A01M 31/00

(52) U.S. Cl. 239/53

(57) ABSTRACT

A scent delivery device including a container containing a scented string. The scented string is deployed through an opening of the container. Once deployed the string releases scent fumes to either attract or repel an animal. The scent delivery device allows for an efficient way to deploy a scent, without wasting the scent used.

### BACKGROUND OF THE INVENTION

The present invention relates to scent delivery device and, more particularly, to a scent delivery device including a container and a string.

The current use of animal repellant or attractant involves spraying a liquid scent on a tree, ground or in the air. The scent may disperse in the wind and disperse from the trees or ground. Therefore, a lot of scent must be used and the scent must be reapplied frequently. The current use is wasteful and the user needs luck for the animal to be attracted in the user's directions.

As can be seen, there is a need for a device that retains a scent and creates a trail for an animal to follow.

### SUMMARY OF THE INVENTION

In one aspect of the present invention, a scent delivery device comprises a container with an opening, and a length of string contained within said container, wherein said length of string is scented and a scent is deployed from said length of string by removing at least a portion of said length of string from said container through said opening.

These and other features, aspects and advantages of the present invention will become better understood with reference to the following drawings, description and claims.

### BRIEF DESCRIPTION OF THE DRAWINGS

FIG. 1 is a perspective view of the invention;

FIG. 2 is an exploded view of the invention illustrating item 22 deploy-ready string ball;

FIG. 3 is a perspective view of the invention shown in use in attractant configuration;

FIG. 4 is a perspective view of the invention shown in use in repellant configuration; and

FIG. 5 is a perspective view of the invention shown in use in attractant configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a scent delivery device including a container containing a scented string. The scented string is deployed through an opening of the container. Once deployed the string releases scent fumes to either attract or repel an animal. The scent delivery device allows for an efficient way to deploy a scent for an animal.

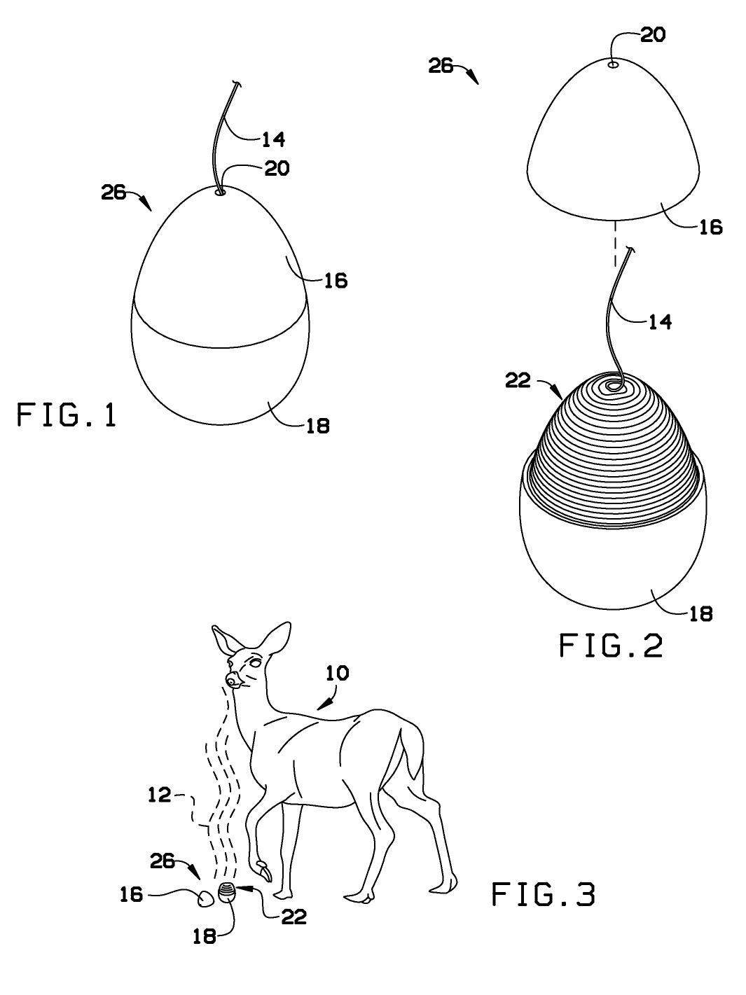

Referring now to FIGS. 1 through 5, the scent delivery device may include a shell container 26. The shell container 26 may include a shell top 16 and a shell base 18. The shell top 16 and the shell base 18 may be attached together to form the shell container 26. The shell top 16 and the shell base 18 may be attached together by snapping, gluing, welding, taping, or any means of attaching. The shell container 26 may be in the shape of an egg, circular, squared, triangular and the like. The shell container 26 may further include an opening 20. In certain embodiments, the opening 20 may be at the top of the shell top 16. However, the opening 20 may be located in other areas of the container shell 26.

In certain embodiments, a length of string 14 may be placed within the shell container 26. The length of string 14 may be made of a cotton twine, or any twine which may retain and disperse a scent fume 12, 13. The length of string 14 may be wrapped into a string ball 22 and placed within the shell container 26. In certain embodiments, the string ball 22 is placed into the shell base 18, while the shell base 18 and the shell top 16 are detached. A liquid scent may be poured on to the string ball 22 and the string ball 22 may absorb the liquid scent. In certain embodiments, about one ounce of liquid scent may be used for about 300 feet of string 14. The shell base 18 and the shell top 16 may then be attached. However, other embodiments may include adding a scent to the length of string prior to and after the attachment of the shell base 18 and the shell top 16.

After the ball of string 14 has absorbed the liquid scent and the shell base 18 and the shell top 16 are attached, the length of string 14 may be pulled through the opening 20 of the shell container 26. Once at least a portion of the length of string 14 is pulled through the opening, the string ball 22 may unwind and the length of string 14 may be laid on the ground. In certain embodiments, up to about 300 feet of the length of string 14 may be dispensed. However, it is envisioned that any amount of length of string 14 may be dispensed from the shell container 26. The scent may then disperse over the area in which the length of string 14 has been laid. The length of string 14 may act as a scent trail for an animal. The scent trail may lead an animal directly to a user.

In certain embodiments, the scent delivery device may further contain a reel. The reel may be used to wind up the length of string 14 into the string ball 22. For example, the length of string 14 may be pulled out and laid on the ground to attract an animal. Once the user is finished, the user may wind the string 14 back into the shell container 26 to create the string ball 22 within the container.

The scent used in the scent delivery device may be an attractant or a repellant. For example, a hunter may use an attractant to attract an animal towards and along the length of string 14, which may act as a trail for the animal. The animal may include, but is not limited to, a wild animal such as deer, bear, turkey, elk, moose, boar and the like. For example, FIG. 3 provides an exemplary deer 10 being attracted to an exemplary attractant scent fume 12. In FIG. 5, the exemplary deer 10 is following the exemplary attractant scent fume 12 along the length of string 14.

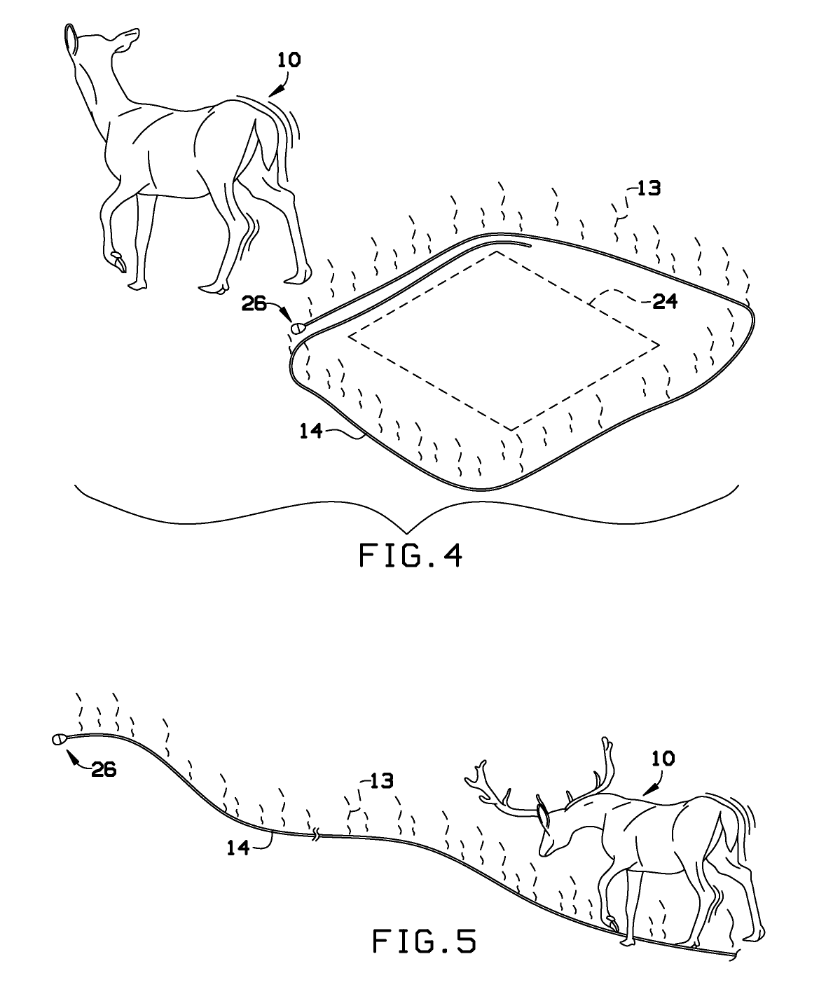

The scent may further be a repellant. A user may use the scent delivery device as a repellant to repel any animal from a desired protected region 24. For example, the length of string 14 may be surrounding an exemplary protected region 24, as demonstrated in FIG. 4. The exemplary protected region 24 may included a garden, flowers and the like. The exemplary repellant scent fume 13 may disperse from the length of string 14 and repel the exemplary deer 14. Another example may include a length of string 14 scented with snake repellant. The length or string 14 may be laid around a campsite and thereby repel snakes from entering. However, it is envisioned that the repellent scent may be used for any animal in which a user would like to repel.

It should be understood, of course, that the foregoing relates to exemplary embodiments of the invention and that modifications may be made without departing from the spirit and scope of the invention as set forth in the following claims.

What is claimed is:

1. A scent delivery device comprising:
a container with an opening; and
a length of string contained within said container, wherein said length of string is scented and a scent is deployed from said length of string by removing at least a portion of said length of string from said container through said opening.

2. The scent delivery device of claim 1, wherein said container comprises a top and a base, wherein said top and said base are separated to place said length of string in said container, and attached to contain said length of string.

3. The scent delivery device of claim 1, wherein said length of string is a ball of string within said container.

4. The scent delivery device of claim 3, wherein said ball of string is scented by pouring a liquid scent into said ball of string.

5. The scent delivery device of claim 4, wherein said length of string is pulled from said opening to unwind the ball of string and disperse said liquid scent.

6. The scent delivery device of claim 1, wherein said length of string is cotton twine.

7. The scent delivery device of claim 1, wherein said scent is an attractant or repellant for an animal.

8. The scent delivery device of claim 7, wherein said animal is a deer.

9. The scent deliver device of claim 7, wherein said length of string creates a scented trail for said animal.

10. The scent delivery device of claim 1, wherein said container is in the shape of an egg.
